(19) United States
(12) Patent Application Publication
(10) Pub. No.: US 2026/0001523 A1
(43) Pub. Date: Jan. 1, 2026

(54) METHOD AND CONTROL DEVICE FOR DETERMINING A BRAKE CYLINDER PRESSURE IN A PNEUMATIC BRAKE SYSTEM OF A COMMERCIAL VEHICLE

(71) Applicant: ZF CV Systems Global GmbH, Bern (CH)

(72) Inventors: Joachim Pracht, Hannover (DE); Ulrich Brockmeyer, Gronau OT Banteln (DE)

(21) Appl. No.: 19/318,185

(22) Filed: Sep. 3, 2025

Related U.S. Application Data
(63) Continuation of application No. PCT/EP2024/054883, filed on Feb. 27, 2024.

(30) Foreign Application Priority Data
Mar. 3, 2023 (DE) 10 2023 105 268.3

(51) Int. Cl. B60T 17/22; B60T 8/32; B60T 13/68

(52) U.S. Cl. CPC B60T 17/221; B60T 8/327; B60T 13/683; B60T 2270/10; B60T 2270/413

(57) ABSTRACT

A method is for determining a brake cylinder pressure in a pneumatic brake system of a commercial vehicle, in which the brake cylinder pressure is estimated via a mathematical model. In a method with which the brake chamber pressure can be determined reliably without using a pressure sensor, the brake cylinder pressure is determined continuously as a function of an air mass flow, which is adjusted by an open or closed state of an electronically controllable solenoid valve arranged outside a control device for the brake cylinder pressure in an air supply line immediately upstream of a brake cylinder, and the physical properties of the air in the chamber of the brake cylinder while taking into account the currently predefined open or closed state of the solenoid valve.

### CROSS-REFERENCE TO RELATED APPLICATIONS

This application is a continuation application of international patent application PCT/EP2024/054883, filed Feb. 27, 2024, designating the United States and claiming priority from German application 10 2023 105 268.3, filed Mar. 3, 2023, and the entire content of both applications is incorporated herein by reference.

### TECHNICAL FIELD

The disclosure relates to a method for determining a brake cylinder pressure in a pneumatic brake system of a commercial vehicle, in which the brake cylinder pressure is estimated via a mathematical model, and also a control device for carrying out the method.

### BACKGROUND

U.S. Pat. No. 6,508,522 B1 discloses a method and a device for estimating a brake pressure in a brake cylinder by using a simplified mathematical model. The mathematical model is restricted to operating conditions of the brake cylinder and dispenses with terms of higher order and with certain fluid-dependent terms. The brake pressure in the brake cylinder is estimated as a function of the displacement of the cylinder piston while the piston is in contact with the rotor of a disc brake for holding the brake pad.

US 2005/0137773 A1 discloses a vehicle brake system for supplying compressed air to a brake chamber. In order to achieve a desired braking reaction, it contains a compressed-air-controlled relay valve for supplying the compressed air to the brake chamber. A solenoid receives a variable signal depending on an input control pressure and supplies this input control pressure to the relay valve as a function of the state of the solenoid. A controller controls the solenoid according to a control model in order to supply the compressed air to the brake chamber and to achieve the desired braking response.

US 2018/0029574 describes a method for operating an automated parking brake, in which a determination and/or setting of a pressure level is carried out via an algorithm for pressure estimation.

CN 113688584 A discloses a method for estimating a brake chamber pressure in a vehicle. The chamber pressure is estimated via a statistical model, in which an inertial connecting pressure with a variable time constant is estimated by using the time.

### SUMMARY

It is an object of the disclosure to specify a method and a device with which the brake chamber pressure can be determined reliably without using a pressure sensor.

This object is achieved by various embodiments of the disclosure. According to an embodiment, to determine a brake cylinder pressure in a pneumatic brake system of a commercial vehicle, in which the brake cylinder pressure is estimated via a mathematical model, the brake cylinder pressure is determined continuously as a function of an air mass flow, which is adjusted by an open or closed state of an electronically controllable solenoid valve arranged outside a control device for the brake cylinder pressure in an air supply line immediately upstream of a brake cylinder, and the physical properties of the air in the chamber of the brake cylinder, while taking into account the currently predefined open or closed state of the solenoid valve.

The aforementioned object is, for example, also achieved by a control device for determining a brake cylinder pressure in a pneumatic brake system of a commercial vehicle, which controls the air flowing into a brake cylinder via an air supply line, wherein an electronically controllable solenoid valve is arranged in the air supply line to the brake cylinder and is connected to a computing unit, which determines the brake cylinder pressure depending on at least one feature of the method proposed in this property rights application.

In the text that follows, the air mass flow is to be understood as the derivative over time of the air mass flowing through the solenoid valve. Since the use of the separate solenoid valve arranged in an air supply line prevents direct pressure measurement by the control device controlling the brake pressure, a real-time estimator which is based on simplified equations in fluid dynamics and thermodynamics is used for the actual brake cylinder pressure in order to save computing time. The response of the solenoid valve and of the brake cylinder is derived experimentally. In particular, the dead times between energization and pneumatic opening and closing of the solenoid valve are taken into account, which increases the accuracy of the real-time estimation. The dead times are likewise derived by measurement.

Such a real-time estimation is suitable in particular for driving dynamics control functions which use a solenoid valve and which intervene in the brake control process. Such a driving dynamics control is represented, for example, by an ABS system, which includes an ABS valve for preventing the locking of the vehicle wheels under full braking. The information about the pressure level in the brake cylinder, in particular during functional transitions (for example during the transition from the normal brake control to the intervention of the ABS system), is of particular importance. However, it can also be used for functional optimization.

In an embodiment, the brake cylinder pressure is calculated on the basis of an “upstream” temperature and “upstream and downstream” pressures of three air mass partial streams, wherein the first partial stream flowing from the control device to the brake cylinder, the second partial stream flowing back from the brake cylinder to the control device and the third partial stream flowing from the brake cylinder into the surroundings of the brake system are taken into account. Considering the properties of the partial streams of the air mass which flow in different directions permits an increase in the accuracy of the brake cylinder pressure to be determined in real time.

In a further embodiment, the air mass partial streams are determined as a function of the pressures upstream and downstream of the solenoid valve and the air temperature upstream of the solenoid valve, from which, together with the physical properties of the air in the chamber of the brake cylinder at the time of the predefined open or closed state, the brake cylinder pressure is determined. The determination of the pressures and of the air temperature can be implemented by measurement using simple means, which simplifies the outlay on measurement for the estimation.

In a further embodiment, the temperature and the volume of the air in the chamber of the brake cylinder are calculated as the physical properties of the air. It can be implemented with simple thermodynamic equations. The volume of the air in the chamber of the brake cylinder can be determined particularly conveniently as a function of a displacement travel of a piston of the brake cylinder in the chamber of the brake cylinder characterizing the brake cylinder pressure. For this purpose, it is merely necessary to determine a travel covered by the piston of the brake cylinder by using a displacement sensor which is intrinsically present.

In a further embodiment, the temperature of the air in the chamber of the brake cylinder is determined as a function of an enthalpy flow and/or a heat flow between the air in the chamber of the brake cylinder and the environment and/or a volume change work. When the solenoid valve is open, a predefined cross-sectional area in the air supply line via which the air mass flow flows is additionally assumed while, when the solenoid valve is closed, a cross-sectional area of zero is defined. Via the two specified cross-sectional areas in the air supply line, firstly the outlay on measurement is reduced and secondly the computational effort is reduced, since it is necessary to calculate with only two fixed variables, which represent the open or closed state of the solenoid valve.

In a further embodiment, an electronically controllable solenoid valve, which is connected to a computing unit that is a constituent part of the control device for determining a brake cylinder pressure in a pneumatic brake system of a commercial vehicle, is arranged in the air supply line to the brake cylinder. The control device includes a pressure sensor for detecting a pilot pressure on the solenoid valve, which is taken into account in order to determine the first partial stream of the air mass flow which flows from the control device to the brake cylinder.

In a further embodiment, the electronically controllable solenoid valve is configured as an ABS valve which is mounted on a vehicle wheel and which is controlled by an ABS controller. The control device is configured in such a way as to control the brake cylinder pressure on both sides of an axle of a vehicle, which means that outlay on hardware is reduced. Such a control device is also designated as an axle modulator. It has two pneumatically independent pressure control channels each having an air input and venting valve, each having a pressure sensor and the control electronics used jointly as a computing unit.

The aspects described here in relation to the method apply equally to the disclosed device. The method disclosed can be implemented, for example, by the computing unit. This can be done by making suitable write and read accesses to a memory assigned to the vehicle. The method is in particular implemented within the motor vehicle in hardware or software or else in a combination of hardware and software. The hardware includes in particular digital signal processors, application-specific integrated circuits, field programmable gate arrays and further suitable switching and computing components.

### BRIEF DESCRIPTION OF DRAWINGS

The invention will now be described with reference to the drawings wherein:

FIG. 1 shows a basic illustration of an embodiment of the device according to the disclosure for a pneumatic brake system on a front axle of a vehicle;

FIG. 2 shows a schematic illustration of the partial streams of the air mass in a pressure control state of the device according to FIG. 1; and,

FIG. 3 shows a schematic illustration of an embodiment of the method according to the disclosure.

### DETAILED DESCRIPTION

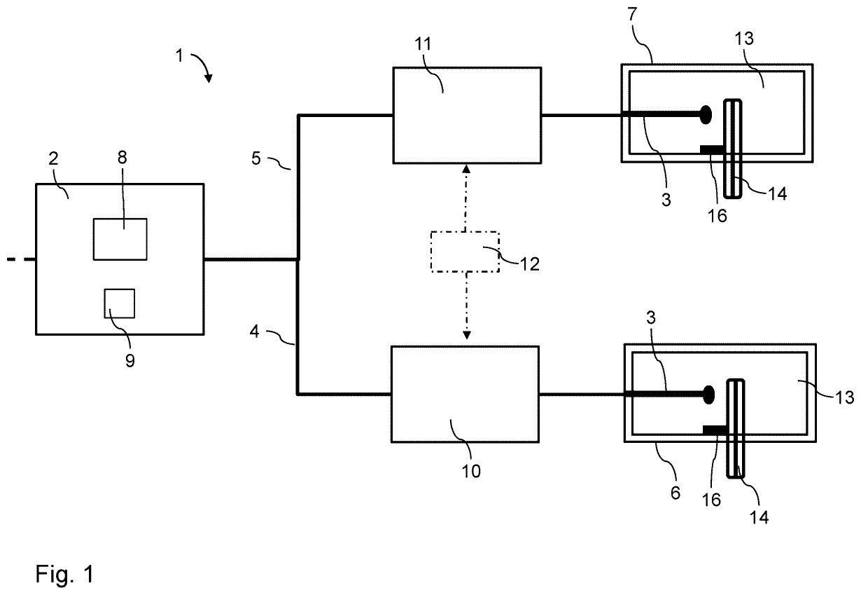

FIG. 1 shows a basic illustration of an embodiment of the device according to the disclosure for a pneumatic brake system of a front axle of a vehicle. The device 1 is configured as an axle modulator 2, which functions as a control device for a brake cylinder pressure in a brake cylinder 6, 7 of a pneumatic brake system. In such a pneumatic brake system, the braking process of the vehicle, carried out by a service brake 14, which may be configured as a disc brake, is assisted in that a piston 3 of the brake cylinder 6, 7 is forced via the compressed air introduced against the service brake arranged on each vehicle wheel.

The axle modulator 2 is connected via air supply lines 4, 5 to a right and a left brake cylinder 6, 7, via which the axle modulator 2 feeds the air into the two brake cylinders 6, 7 in order to assist a braking process on the wheels of the front axle of the vehicle. Each air supply line 4, 5, together with a brake cylinder 6, 7, forms a separate brake control strand. The axle modulator 2 includes control electronics 8 for determining the supply of air provided for the respective brake cylinder 6, 7, and a pressure sensor 9 for determining the pressure in the air supply lines 4, 5. Installed directly upstream of the respective brake cylinder 6, 7 in the respective air supply line 4, 5 is, in each case, an ABS valve 10, 11, the open or closed state of which is controlled by an ABS controller 12. The ABS controller 12 prevents the wheels of the vehicle from locking during full braking and the driver of the vehicle thus losing the control of the vehicle. This is achieved as a result of the repeated lowering and re-raising of the brake pressure by using the electronically controlled ABS valves 10, 11. The wheels are braked in a metered manner by changing the open state of the ABS valves.

The axle modulator 2, as installed on the front axle, has only one pressure sensor 9 and can therefore control only one pressure. This pressure is applied to both wheels on the front axle which, as a result, are loaded with the same pressure. Since each front wheel has its own ABS valve 10, 11, the wheel pressures can be remodulated on an individual wheel basis thereby without a pressure sensor being able to measure the pressures modulated by the ABS valve 10, 11. A real-time estimator, described below, can then always be used if an ABS valve 10, 11 is situated between the axle modulator 2 and the wheel, since the actuation of the ABS valve 10, 11 leads to the measured pressure on the axle modulator 2 no longer coinciding with the wheel pressures.

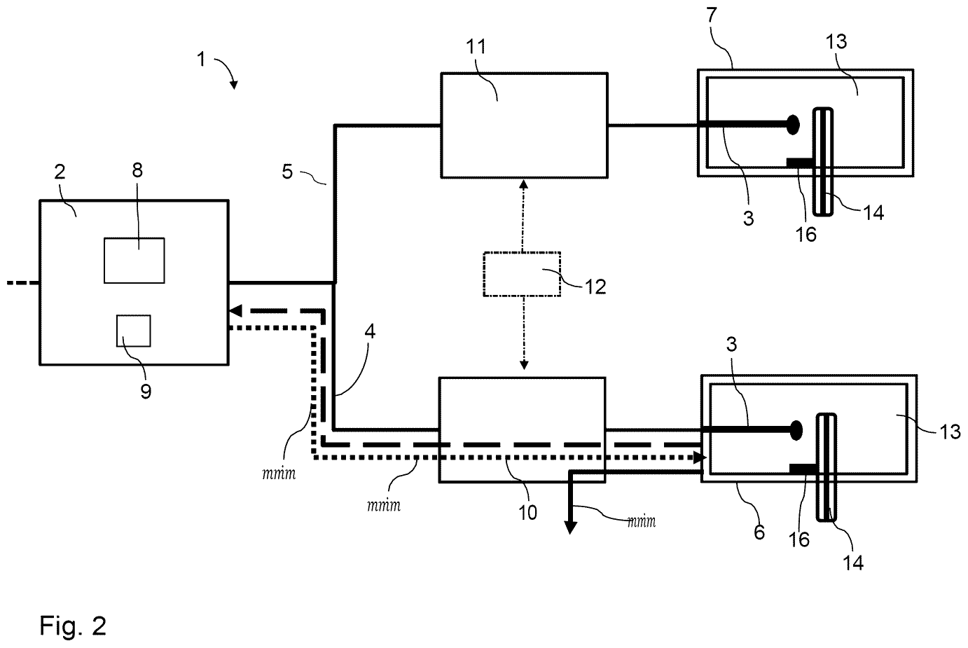

Since, during the actuation of the ABS valves 10, 11, the brake cylinder pressure p_{BrkCyl} in the brake cylinders 6, 7 cannot be determined by the pressure sensor 9 of the axle modulator 2, this is estimated as a function of an air mass flow m flowing through an ABS valve 10, 11. As can be seen from FIG. 2, the air mass flow \dot{m} in a pressure control strand is composed of three partial streams \dot{m}1, \dot{m}2, and \dot{m}3. The first partial stream \dot{m}1 flows from the axle modulator 2 through the ABS valve 10 to the brake cylinder 6, while the second partial stream \dot{m}2 flows from the brake cylinder 6 back to the axle modulator 2 through the ABS valve 10. The third partial stream \dot{m}3 flows out from the chamber 13 of the brake cylinder 6 into the environment via the ABS valve 10.

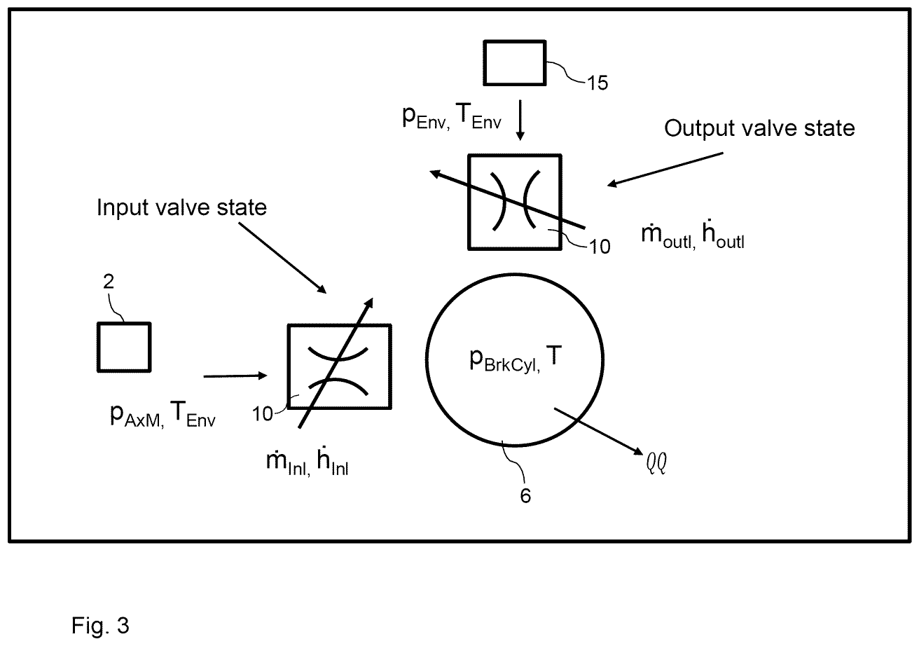

The estimation of the air mass flow \dot{m} is carried out by using a mathematical model, as shown in FIG. 3 for one pressure control strand. The ABS valve 10 is shown with a first state as an input valve, into which an air mass flow \dot{m} flows at a pressure pAxM measured by the pressure sensor 9 as a pilot pressure in the axle modulator 2 and at an ambient temperature T_{Env}. Furthermore, the ABS valve is considered in a second state as an output valve. The ABS valve 10 is closed in one of the states. A cross-sectional area A of the air supply line is zero in this case. In the open, second state of the ABS valve 10, this cross-sectional area is assumed to be 100%. Furthermore, during the calculation, the incoming air mass flow \dot{m}_{Inl} and its enthalpy flow \dot{h}_{Inl} are taken into account. As a result of the pressure p_{BrkCyl} occurring in the brake cylinder 6 and the temperature T that occurs, the result is a heat flow \dot{Q} discharged to the outside and to be taken into account. An air mass flow \dot{m}ₒᵤₜₗ with a further enthalpy flow \dot{h}ₒᵤₜₗ are also viewed as output variables of the ABS valve 10. The air pressure p_{Env} of the environment and the ambient temperature T_{Env} are taken into account as further input variables.

From this model, the brake chamber pressure p_{BrkCyl} can be estimated in real time on the basis of Equation 1:

$${p}_{BrkCyl } = \frac{\int \dot{m} dt \times R T}{V} , \qquad Eq . 1$$

where:
p_{BrkCyl} is the brake cylinder pressure,
\dot{m} the air mass flow,
R the specific gas constant of air,
T the air temperature in the brake cylinder
V the volume of the air in the chamber of the brake cylinder.

The individual components of Eq.1, \dot{m}, T and V, can be calculated as follows.

The volume V is determined from:

$$V = {A}_{BrkCyl} * x \{ {p}_{BrkCyl} ) + {V}_{tot} , \qquad Eq . 2$$

where:
A_{BrkCyl} is the area of the base of the brake cylinder,
x(p_{BrkCyl}) the displacement of the piston in the brake cylinder,
Vₜₒₜ the dead volume of the brake cylinder.

The displacement of the piston 3 in the brake cylinder 6 is determined via a displacement sensor 16.

The air mass flow \dot{m} is calculated from the following equation:

$$\dot{m} = A * {C}_{q} * {C}_{m} * \frac{{p}_{up}}{\sqrt{{T}_{up}}} , \qquad Eq . 3$$

where:
A is the cross-sectional area of the air supply line
C_{q} a flow coefficient (factor to compensate for the effective area of the air mass flow),
Cₘ a flow parameter,
pᵤₚ an “upstream” pressure,
Tᵤₚ an “upstream” temperature.

The temperature T results as follows:

$$T = \int \frac{( \dot{h} - \dot{Q} - pBrkCyl * V / Cv - ( \dot{m} * T )}{m} , \qquad Eq . 4$$

where:
   \dot{h} is the enthalpy flow,
   \dot{Q} the flow of heat between air in the brake chamber volume and the environment,
   V the volume change,
   m the air mass in the volume.

Alternatively, the pressure gradients can also be derived from experience or experiments.

The solution described is not restricted to the application of wheels of the front axle, but can also be used for rear axles if a vehicle configuration requires the use of ABS valves on wheels of the rear axle.

It is understood that the foregoing description is that of the preferred embodiments of the invention and that various changes and modifications may be made thereto without departing from the spirit and scope of the invention as defined in the appended claims.

### REFERENCE SIGNS

1 Device
2 Axle modulator
3 Piston of the brake cylinder
4 Air supply line
5 Air supply line
6 Brake cylinder
7 Brake cylinder
8 Control electronics
9 Pressure sensor
10 ABS valve
11 ABS valve
12 ABS controller
13 Chamber of the brake cylinder
14 Service brake
15 Environment
16 Displacement sensor

1. A method for determining a brake cylinder pressure in a pneumatic brake system of a commercial vehicle, in which the brake cylinder pressure is estimated via a mathematical model, the method comprising:
continuously determining the brake cylinder pressure as a function of an air mass flow which is adjusted by an open or closed state of an electronically controllable solenoid valve arranged outside a control device for the brake cylinder pressure in an air supply line immediately upstream of a brake cylinder and physical properties of air in a chamber of the brake cylinder while taking into account whether the solenoid valve is in the open or closed state.

2. The method of claim 1 further comprising determining a response of at least one of the electronically controlled solenoid valve and the brake cylinder by measurement.

3. The method of claim 1, wherein dead times between energization and pneumatic opening or closing of the electronically controllable solenoid valve are derived by measurement.

4. The method of claim 1, wherein the brake cylinder pressure is calculated on a basis of an upstream temperature and pressures upstream and downstream of three air mass partial streams, wherein a first partial stream flowing from the control device to the brake cylinder, a second partial stream flowing back from the brake cylinder to the control device, and a third partial stream flowing from the brake cylinder into the surroundings of the brake system, are taken into account.

5. The method of claim 4, wherein the three air mass partial streams are determined as a function of the pressures upstream and downstream of the solenoid valve and the air temperature upstream of the solenoid valve, from which, together with the physical properties of the air in the chamber of the brake cylinder at the time of the predefined open or closed state, the brake cylinder pressure is determined.

6. The method of claim 1, wherein a temperature and a volume of the air in the chamber of the brake cylinder are calculated as the physical properties of the air.

7. The method of claim 6, wherein the volume of the air in the chamber of the brake cylinder is determined as a function of a displacement travel of a piston in the chamber of the brake cylinder characterizing the brake cylinder pressure.

8. The method of claim 6, wherein the temperature of the air in the chamber of the brake cylinder is determined as a function of at least one of an enthalpy flow and a heat flow between the air in the chamber of the brake cylinder and an environment and/or a volume change work.

9. The method of claim 1, wherein, when the solenoid valve is open, a cross-sectional area in the air supply line via which the air mass flow flows is assumed, while, when the solenoid valve is closed, the cross-sectional area is defined as zero.

10. The method of claim 1, wherein the electronically controllable solenoid valve is an ABS valve.

11. A control device for determining a brake cylinder pressure in a pneumatic brake system of a commercial vehicle, which controls air flowing into a brake cylinder via an air supply line, wherein an electronically controllable solenoid valve is arranged in the air supply line to the brake cylinder, the control device comprising:
a computing unit including a processor and a non-transitory computer readable medium having program code stored thereon; and,
said program code being configured, when executed by said processor, to continuously determine the brake cylinder pressure as a function of an air mass flow which is adjusted by an open or closed state of the electronically controllable solenoid valve arranged outside the control device for the brake cylinder pressure in the air supply line immediately upstream of the brake cylinder and physical properties of air in a chamber of the brake cylinder while taking into account whether the solenoid valve is in the open or closed state.

12. The control device of claim 11, wherein a pressure sensor for detecting a pilot pressure is disposed on the solenoid valve.

13. The control device of claim 11, wherein the computing unit is a constituent part of the control device.

14. The device of claim 11, wherein the electronically controllable solenoid valve is an ABS valve which is mounted on a vehicle wheel and which is controlled by an ABS controller.

15. The control device of claim 11, wherein the control device is configured to control the brake cylinder pressure on both sides of an axle of a vehicle.
